(19) United States
(12) Patent Application Publication
(10) Pub. No.: US 2021/0184865 A1
(43) Pub. Date: Jun. 17, 2021

(54) IN-VEHICLE CONTROLLER AND METHOD FOR EMBEDDING CERTIFICATE FOR SAME

(71) Applicants: HYUNDAI MOTOR COMPANY, SEOUL (KR); KIA MOTORS CORPORATION, SEOUL (KR)

(72) Inventor: Ho Jin JUNG, Bucheon-si (KR)

(73) Assignees: HYUNDAI MOTOR COMPANY, SEOUL (KR); KIA MOTORS CORPORATION, SEOUL (KR)

(21) Appl. No.: 16/952,948

(22) Filed: Nov. 19, 2020

(30) Foreign Application Priority Data
Dec. 16, 2019 (KR) 10-2019-0167555

(51) Int. Cl. H04L 9/32; H04L 9/30

(52) U.S. Cl. CPC H04L 9/3263; H04L 9/3247; H04L 9/30

(57) ABSTRACT

An in-vehicle controller and a method for embedding a certificate for the same are provided. disclosure The method may include: transmitting a public key request from a first server to a controller requiring a certificate embedding; generating a key pair including a private key and a public key by a hardware security module included in the controller according to the public key request and transmitting the public key in the key pair to the first server via the controller; transmitting a hash of a certificate signing request (CSR) message to the controller when the first server generates the CSR message based on the public key; when the hardware security module signs the hash with the private key, transmitting the signed hash to the first server via the controller; and completing a generation of the CSR message by the first server based on the signed hash.

### CROSS-REFERENCE TO RELATED APPLICATION

The present application claims priority to and the benefit of Korean Patent Application No. 10-2019-0167555, filed on Dec. 16, 2019, which is hereby incorporated by reference in its entirety.

### TECHNICAL FIELD

The present disclosure relates to an in-vehicle controller and a method for embedding a certificate for the same.

### BACKGROUND

Electromotive vehicles which can be charged with external power, for example, electric vehicles (EV) and plug-in hybrid electric vehicles (PHEV), are charged using electric vehicle supply equipment (EVSE) and power line communication (PLC), in general.

Conventionally, however, only some services such as setting of a charge amount are executed through PLC and an external identification means (EIM), for example, a credit card payment terminal, provided outside the EVSE is usually used for payment for charged power. However, a plug-and-charge (PnC) technique that allows automatic payment through communication between a vehicle and a charger has been introduced according to development of technology for PLC middleware communication and establishment of new V2G standards (i.e., ISO 15118-2).

Accordingly, a procedure through which charging to payment can be processed through PLC is provided, but vehicles require a higher level of security. For example, in a case where an asymmetric key based certificate security method is applied when communication according to the PnC technique is performed, a permission settings certificate and a private key need to be safely stored in a vehicle in order to certify that the vehicle is authenticated for a charger and also need to be prevented from leaking during an embedding process in production.

In a general private key and certificate embedding method, a server generates a pair of a private key and a public key, generates a certificate on the basis of the public key and then transmits the private key and the certificate to a controller. Although this method has the advantages of minimizing process change and simplifying processes according to simultaneous generation and embedding of keys and a certificate through the server, a private key may be exposed to the outside in a process in which the server transmits the private key to a controller, and if the server is hacked, important information related to a vehicle and a client may be exposed.

Accordingly, a high level of security may be desirable for PnC environment.

### SUMMARY

Accordingly, the present disclosure provides an in-vehicle controller and a method for embedding a certificate for the same which have improved security.

It will be appreciated by persons skilled in the art that the object that could be achieved with the present disclosure are not limited to what has been particularly described hereinabove and the above and other objects that the present disclosure could achieve will be more clearly understood from the following detailed description.

A method for embedding a certificate for an in-vehicle controller in some forms of the present disclosure includes: transmitting a public key request from a first server to a controller requiring certificate embedding; generating a key pair including a private key and a public key by a hardware security module included in the controller according to the public key request and transmitting the public key in the key pair to the first server via the controller; transmitting a hash of a certificate signing request (CSR) message to the controller when the first server generates the CSR message on the basis of the public key; when the hardware security module signs the hash with the private key, transmitting the signed hash to the first server via the controller; and completing generation of the CSR message by the first server on the basis of the signed hash.

For example, the method for embedding a certificate for an in-vehicle controller may further include: transmitting the generated CSR message from the first server to a second server; verifying the CSR message and generating a certificate by the second server; and transmitting the certificate to the hardware security module via the first server and the controller.

For example, the first server may generate the CSR message on the basis of the public key and identification information of the controller.

For example, the first server may include a factory server and the second server may include a vehicular public-key infrastructure (vKPI) server.

For example, the first server may be connected to the controller on the basis of vehicle communication through production equipment, and the first server may be connected to the second server on the basis of external Internet communication.

For example, the hardware security module may be mounted as an on-chip module in a microprocessor computer of the controller.

For example, the controller may include a charging controller for electromotive vehicles.

Furthermore, a method for embedding a certificate for a controller requiring certificate embedding in some forms of the present disclosure may include: an internal hardware security module (HSM) generating a key pair including a private key and a public key upon reception of a public key request from a server connected in a wired manner; transmitting the public key in the generated key pair to the server; when a hash of a certificate signing request (CSR) message generated on the basis of the public key is transmitted from the server, the hardware security module signing the hash with the private key and transmitting the signed hash to the server; and when a certificate is transmitted from the server, the hardware security module completing verification of the certificate and then storing the certificate.

Furthermore, a controller requiring certificate embedding in some forms of the present disclosure includes a hardware security module, wherein the hardware security module is configured to: generate a key pair including a private key and a public key, extract the public key from the generated key pair and transmit the public key to the controller upon reception of a first public key request from the controller; when a hash of a certificate signing request (CSR) message generated on the basis of the public key is transmitted from the controller, sign the hash with the private key and transmit the signed hash to the controller; and when a certificate is transmitted from a server, complete verification of the certificate and store the certificate.

For example, the controller may transmit the first public key request to the hardware security module when a second public key request is received from a server connected to the controller in a wired manner.

For example, the server connected in a wired manner may include a factory server connected to a vehicular public-key infrastructure (vKPI) server.

For example, the controller may include a charging controller for electromotive vehicles.

For example, the hardware security module may be mounted as an on-chip module in a microprocessor computer of the controller.

It may be possible to prevent a private key from leaking in a certificate embedding process through the in-vehicle controller and the method for embedding a certificate for the same in some forms of the present disclosure configured as above.

Particularly, since the private key is not transmitted to the outside after being generated in a hardware security module in the controller, there is no risk that the private key will be exposed.

It will be appreciated by persons skilled in the art that the effects that can be achieved with the present disclosure are not limited to what has been particularly described hereinabove and other advantages of the present disclosure will be more clearly understood from the following detailed description.

### DRAWINGS

In order that the disclosure may be well understood, there will now be described various forms thereof, given by way of example, reference being made to the accompanying drawings, in which:

FIG. 1 is a diagram for describing a certificate embedding environment in some forms of the present disclosure.

FIG. 2 illustrates an example of module architecture construction for communication between a hardware security module and a charging controller in some forms of the present disclosure.

FIG. 3 is a flowchart illustrating an example of a certificate embedding process in some forms of the present disclosure.

The drawings described herein are for illustration purposes only and are not intended to limit the scope of the present disclosure in any way.

### DETAILED DESCRIPTION

The detailed description of the exemplary embodiments of the present disclosure will be given to enable those skilled in the art to implement and practice the disclosure with reference to the attached drawings. However, the present disclosure can be implemented in various different forms and is not limited to embodiments described herein. In addition, parts that are not related to description will be omitted for clear description in the drawings, and the same reference numbers will be used throughout this specification to refer to the same or like parts.

Throughout the specification, when it is said that some part “includes” a specific element, this means that the part may further include other elements, not excluding the same, unless otherwise mentioned. In addition, parts denoted by the same reference numeral refer to the same component throughout the specification.

In some forms of the present disclosure, a method for embedding a certificate in an in-vehicle controller more safely is proposed as a method for generating a private key that should not be exposed to the outside in a controller.

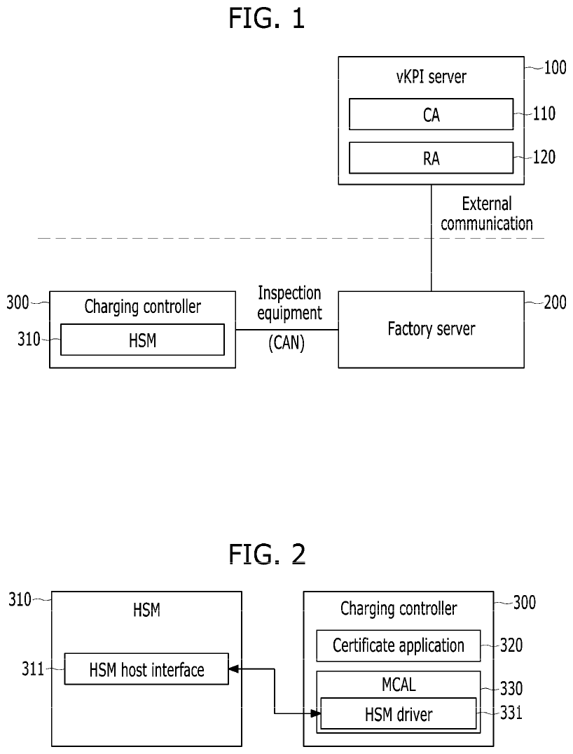

Prior to description of a certificate embedding method in some forms of the present disclosure, a certificate embedding environment will be described first with reference to FIG. 1.

FIG. 1 is a diagram for describing a certificate embedding environment in some forms of the present disclosure. Although a target into which a certificate is embedded is assumed to be a charging controller for supporting the PnC technique in FIG. 1, this is exemplary and the present disclosure is not limited thereto. The present disclosure can be applied to any controller that requires high security and certificate embedding.

Referring to FIG. 1, a vehicular public-key infrastructure (vKPI) server 100, a factory server 200 on the side of a controller factory or a vehicle factory, and a charging controller 300 that is a certificate embedding target are involved in embedding of a certificate.

The vKPI server 100 may be connected to the factory server 200 through external communication, for example, Internet communication, and the factory server 200 may be connected to the charging controller 300 through inspection equipment based on controller area network (CAN) communication.

Hereinafter, each component will be described in detail.

First, the vKPI server 100 may include a certificate authority (CA) 110 which issues certificates and a registration authority (RA) 120 which performs authentication such as identification and data maintenance instead of the CA and registers a certificate signing request (CSR) of a user. When the RA 120 receives a CSR including a public key from a subordinate server such as the factory server 200, the RA 120 can verify the CSR and request certificate registration and issuance from the CA 110 to be issued a certificate. Accordingly, the RA 120 can execute a function of delivering the issued certificate to the subordinate server.

The factory server 200 can execute a function of mediating communication between the charging controller of a production line managed thereby and the vKPI server 100.

The charging controller 300 needs to hold certificates and private keys in order to support the PnC function. To safely acquire certificates and private keys, the charging controller 300 may include a hardware security module (HSM) 310. The HSM 310 may be mounted as an on-chip module in a microprocessor computer (MICOM) of the controller, but the present disclosure is not limited thereto.

The HSM 310 generally refers to an encryption processor specially designed to protect life cycles of encryption keys and performs encryption processing, key protection and key management in an enhanced anti-forgery device. An HSM used in a vehicle control domain generally includes a secure memory capable of safely storing keys. For example, the secure memory includes a RAM or a ROM dedicated for HSMs with high security separately from a host system, and HSMs can execute functions relatively secured from attacks of potential attackers by performing a series of operations through a dedicated central processing unit (CPU). Particularly, the HSM 310 in some forms of the present disclosure includes a true random number generator (TRNG) and can independently generate pairs of private-keys and public keys.

FIG. 2 illustrates an example of a module architecture construction for communication between the hardware security module and the charging controller in some forms of the present disclosure.

Referring to FIG. 2, the HSM 310 may include an HSM host interface 311 and the charging controller 300 may include a certificate application 320 and a microcontroller abstraction layer (MCAL) 330. The certificate application 320 defines processes necessary for certificate embedding and management and operations according thereto, and the MCAL 330 may include an internal driver for using internal devices of the microprocessor computer (i.e., for providing an interface to a higher layer). Particularly, the MCAL 330 may include an HSM driver 331 to directly access the HSM host interface 311 of the HSM 310.

The aforementioned architecture construction shows only parts in some forms of the present disclosure, and the actual architecture of the HSM 310 may further include a secure memory, a security application, a real-time operating system (RTOS), a cryptographic algorithm, an HSM MCAL, and the like.

The charging controller 300 serves as a host for the HSM 310, and the HSM 310 can execute the following functions through the host.

For example, when the host requests a public key, the HSM 310 may generate a private-key/public-key pair using the TRNG, store the same therein and then transmit only the public key to the host.

As another example, when the host requests data signing, the HSM 310 may generate a signature for input data and transmit the signature to the host.

As another example, when the host requests certificate installation, the HSM 310 may verify a certificate, store the certificate and transmit a verification result to the host.

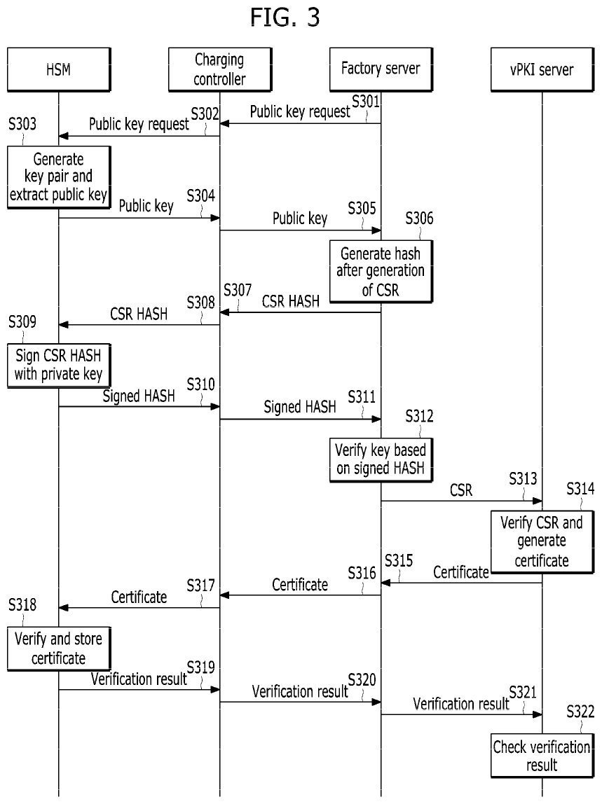

A certificate embedding process according to an embodiment will be described on the basis of the above-described environment configuration with reference to FIG. 3.

FIG. 3 is a flowchart illustrating an example of a certificate embedding process in some forms of the present disclosure.

First, the factory server 200 requests a public key from the charging controller 300 of a corresponding line (S301). Accordingly, the charging controller 300 serving as a host for the HSM 310 requests the public key from the HSM 310 (S302) and the HSM 310 generates a key pair including a private key and the public key, extracts the public key from the generated key pair (S303) and transmits the public key to the charging controller 300 serving as the host (S304).

The charging controller 300 transmits the public key to the factory server 200 (S305), and the factory server 200 generates a certificate signing request (CSR) message on the basis of the received public key and an ID value of the controller 300 and then generates a CRS hash (S306). Here, a secure hash algorithm (SHA) function may be used to generate the CRS hash, but the present disclosure is not limited thereto.

The CSR hash may be transmitted from the factory server 200 to the HSM 310 (S308) via the charging controller 300 (S307).

The HSM 310 signs the CSR hash using the previously generated private key (S309) and transmits the signed hash to the charging controller 300 (S310).

The signed hash is transmitted from the charging controller 300 to the factory server 200 (S311), and the factory server 200 completes generation of the CSR message on the basis of the signed hash (S312). Here, completion of generation of the CSR message may mean that verification of the private-key/public key pair is completed by verifying the signed hash on the basis of the public key.

Accordingly, the factory server 200 transmits a CSR to the vPKI server 100 (S313), and the vPKI server 100 can verify the CSR and generate a certificate on the basis of the CSR upon successful verification of the CSR (S314).

The generated certificate is transmitted to the factory server 200 (S315), the factory server 200 transmits the certificate to the charging controller 300 (S316), and the charging controller 300 delivers the certificate to the HSM 310 (S317).

Upon reception of the certificate, the HSM 310 verifies the certificate, stores (installs) the certificate upon successful verification of the certificate (S318) and transmits the verification result to the charging controller 300 (S319).

The verification result is finally transmitted from the charging controller 300 to the vPKI server 100 (S321) via the factory server 200 (S320).

Accordingly, the vPKI server 100 checks the verification result, and thus the certificate embedding procedure can be completed (S322).

According to the certificate embedding method described above, there is no risk that a private key will be exposed to the outside in a certificate embedding process because the private key is not transmitted to the outside after being generated in a security module in a controller which requires embedding of a certificate.

Accordingly, a charging controller in which a certificate has been embedded as described above can safely support the PnC function.

The above-described present disclosure can be realized as computer-readable code in a medium in which a program is recorded. Computer-readable media include all kinds of recording devices in which data readable by computer systems is stored. Examples of computer-readable media include a hard disk drive (HDD), a solid state drive (SSD), a silicon disk drive (SDD), a ROM, a RAM, a CD-ROM, a magnetic tape, a floppy disk, an optical data storage device, etc.

Therefore, the above embodiments are therefore to be construed in all aspects as illustrative and not restrictive. The scope of the present disclosure should be determined by the appended claims and their legal equivalents, not by the above description, and all changes coming within the meaning and equivalency range of the appended claims are intended to be embraced therein.

What is claimed is:

1. A method for embedding a certificate for an in-vehicle controller, the method comprising:
transmitting a public key request from a first server to a controller requiring certificate embedding;
generating a key pair including a private key and a public key by a hardware security module included in the controller according to the public key request;
transmitting the public key in the key pair to the first server via the controller;
transmitting a hash of a certificate signing request (CSR) message to the controller when the first server generates the CSR message based on the public key;
when the hardware security module signs the hash with the private key, transmitting the signed hash to the first server via the controller; and
completing generation of the CSR message by the first server based on the signed hash.

2. The method according to claim 1, wherein the method further comprises:
transmitting the generated CSR message from the first server to a second server;
verifying the CSR message and generating a certificate by the second server; and
transmitting the certificate to the hardware security module via the first server and the controller.

3. The method according to claim 1, wherein the method comprises:
generating, by the first server, the CSR message based on the public key and identification information of the controller.

4. The method according to claim 1, wherein the first server includes a factory server and the second server includes a vehicular public-key infrastructure (vKPI) server.

5. The method according to claim 2, wherein the method comprises:
connecting the first server to the controller via vehicle communication through production equipment; and
connecting the first server to the second server via external Internet communication.

6. The method according to claim 1, wherein the method comprises:
mounting the hardware security module as an on-chip module in a microprocessor computer of the controller.

7. The method according to claim 1, wherein the controller includes a charging controller for electromotive vehicles.

8. A method for embedding a certificate for a controller requiring certificate embedding, the method comprising:
receiving, from a server connected in a wired communication, a public key request;
when the public key request is received, generating, by a hardware security module (HSM), a key pair including a private key and a public key;
transmitting the public key in the generated key pair to the server;
when a hash of a certificate signing request (CSR) message generated based on the public key is transmitted from the server, signing, by the HSM, the hash with the private key and transmitting the signed hash to the server; and
when a certificate is transmitted from the server, completing, by the HSM, verification of the certificate and then storing the certificate.

9. A non-transitory computer-readable recording medium having a program recorded thereon, the program to direct a processor to perform acts of:
transmitting a public key request from a first server to a controller requiring certificate embedding;
generating a key pair including a private key and a public key by a hardware security module included in the controller according to the public key request;
transmitting the public key in the key pair to the first server via the controller;
transmitting a hash of a certificate signing request (CSR) message to the controller when the first server generates the CSR message based on the public key;
when the hardware security module signs the hash with the private key, transmitting the signed hash to the first server via the controller; and
completing generation of the CSR message by the first server based on the signed hash.

10. An in-vehicle controller comprising:
a hardware security module configured to:
generate a key pair including a private key and a public key;
extract the public key from the generated key pair;
transmit the public key to the controller when a first public key request is received from the controller;
generate a hash of a certificate signing request (CSR) message based on the public key;
when the hash of the CSRmessage is transmitted from the controller, sign the hash with the private key and transmit the signed hash to the controller; and
when a certificate is transmitted from a server, complete verification of the certificate and store the certificate.

11. The in-vehicle controller according to claim 10, wherein the controller is configured to:
transmit the first public key request to the hardware security module when a second public key request is received from a server connected to the controller in a wired communication.

12. The in-vehicle controller according to claim 11, wherein the server includes a factory server connected to a vehicular public-key infrastructure (vKPI) server.

13. The in-vehicle controller according to claim 10, wherein the controller includes a charging controller for electromotive vehicles.

14. The in-vehicle controller according to claim 10, wherein the hardware security module is mounted as an on-chip module in a microprocessor computer of the controller.
